(19) United States
(12) Patent Application Publication
(10) Pub. No.: US 2011/0105261 A1
(43) Pub. Date: May 5, 2011

(54) Tensioner

(76) Inventor: Yahya Hodjat, Oxford, MI (US)

(21) Appl. No.: 12/589,947

(22) Filed: Oct. 30, 2009

(51) Int. Cl. F16H 7/12

(52) U.S. Cl. 474/135

(57) ABSTRACT

A tensioner comprising a torsion spring, a pulley directly journalled to an end of the torsion spring, an elastomeric damping member constrained within a torsion spring coil through an arc of contact of at least 270°, and the elastomeric damping member in damping contact with the torsion spring coil.

### FIELD OF THE INVENTION

The invention relates to a tensioner, and more particularly to a tensioner having an elastomeric damping member constrained within a torsion spring coil through an arc of contact of at least 270°.

### BACKGROUND OF THE INVENTION

The main purpose of a belt tensioner is to prolong the life of an engine or accessory drive belt. The most typical use for such automatic belt tensioners is on front-end accessory drives in an automobile engine. This drive includes pulley sheaves for each accessory the belt is required to power, such as the air conditioner, water pump, fan and alternator. Each of these accessories requires varying amounts of power at various times during operation. These power variations create a slackening and tightening situation of each span of the belt. The belt tensioner is utilized to absorb these power variations.

Representative of the art is U.S. Pat. No. 6,224,028 to Tanaka which discloses a cantilever shaft assembly includes a steel pipe firmly secured at one end to a wall surface of a stationary support member, and a core shaft made from a synthetic resin and having a body portion removably fitted in the steel pipe and an end portion located outside the steel pipe. The end portion forms a free end of the cantilever shaft assembly and rotatably supports thereon a rotating member such as a driven sprocket. The core shaft and the steel pipe are locked and held together by a locking device such as a pin or a key. The cantilever shaft assembly is light in weight and can be easily repaired at a low cost when the end portion of the synthetic resin core shaft is damaged or worn out.

What is needed is a tensioner having an elastomeric damping member constrained within a torsion spring coil through an arc of contact of at least 270°. The present invention meets this need.

### SUMMARY OF THE INVENTION

The primary aspect of the invention is to provide a tensioner having an elastomeric damping member constrained within a torsion spring coil through an arc of contact of at least 270°.

Other aspects of the invention will be pointed out or made obvious by the following description of the invention and the accompanying drawings.

The invention comprises a tensioner comprising a torsion spring, a pulley directly journalled to an end of the torsion spring, an elastomeric damping member constrained within a torsion spring coil through an arc of contact of at least 270°, and the elastomeric damping member in damping contact with the torsion spring coil.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a top perspective view of the tensioner.

FIG. 2 is a bottom perspective view of the tensioner.

FIG. 3 is an exploded view of an alternate embodiment of the tensioner.

FIG. 4 is an exploded view of an alternate embodiment of the tensioner.

FIG. 5 is a bottom view of the embodiment in FIG. 4.

FIG. 6 is an exploded view of an alternate embodiment of the tensioner.

FIG. 7 is a bottom view of the embodiment in FIG. 6.

### DETAILED DESCRIPTION OF THE PREFERRED EMBODIMENT

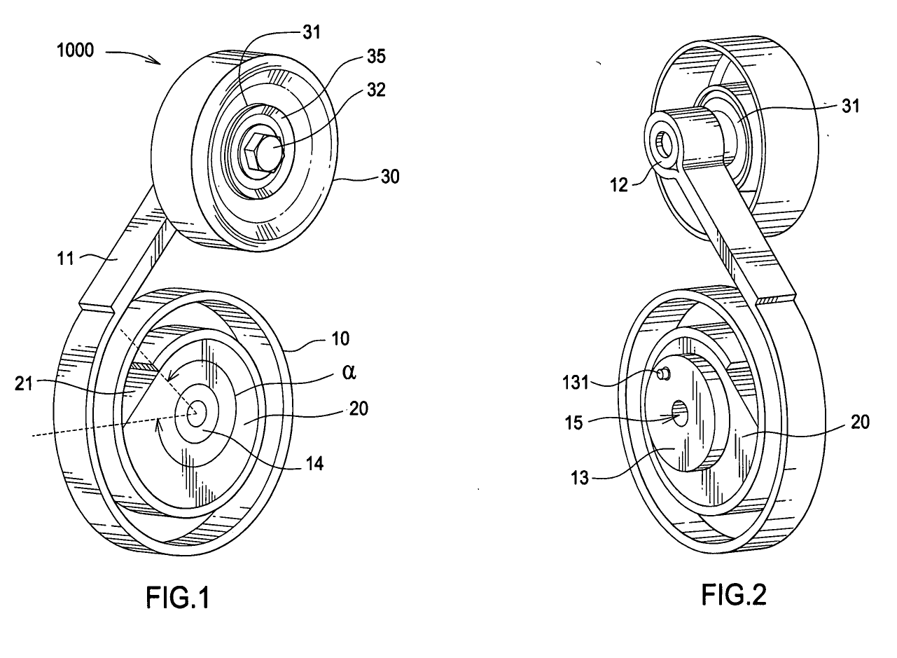

FIG. 1 is a top perspective view of the tensioner. Tensioner 1000 comprises torsion spring 10. Torsion spring 10 is wound. The number of coils is a function of the spring force to be exerted upon a belt. Torsion spring 10 is shown as a flat spring, but it may also be round or rectangular in cross section. The inventive tensioner uses a torsion spring wherein a relatively small winding or unwinding of the torsion spring results in a large amplitude change at the arm end of the torsion spring.

Arm 11 is an extended end of the torsion spring. Arm 11 extends from the last coil of the torsion spring. Unlike the prior art, the inventive tensioner combines the tensioner housing and tensioner arm into the single the torsion spring, simplifying the device and reducing the cost. However, there is no decrease in performance and large tensioner amplitudes are obtained by small spring torsional winding and unwinding. The tensioner can be set in application in a way that the spring either winds or unwinds during operation.

Pulley 30 is journalled to arm 11 through a bearing 31. Fastener 32 mounts bearing 31 to damping member 12. Damping member 12 may be included or omitted from the tensioner assembly.

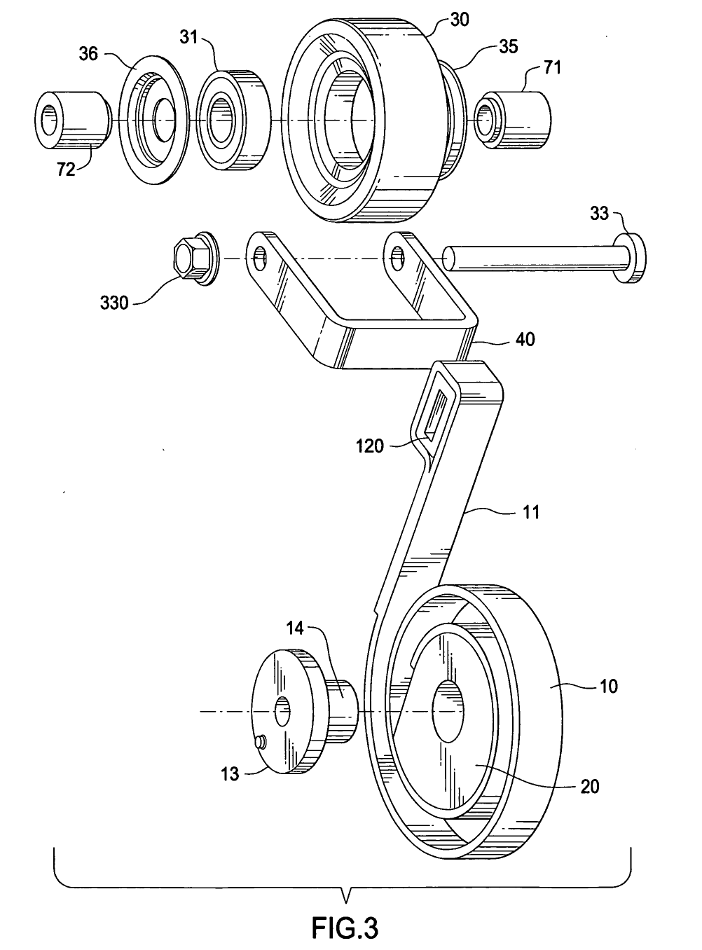

Elastomeric damping member 20 is confined within an inner coil of the torsion spring. Torsion spring 10 comprises at least one coil of 360° and may comprise two or more coils depending upon the user design parameters. The embodiment in FIG. 2 comprises two coils as measured from the innermost end to the arm 11 which extends on a tangent. Member 20 contacts the torsion spring coil preferably through a contact arc α of at least 270°. However, the inventive tensioner will also accommodate a contact arc α of less than 270° where a reduced damping effect is desired. Member 20 is in direct damping contact with the torsion spring coil. Member 20 further comprises a flat surface 21 which prevents torsion spring 10 from winding about member 20 during use.

Damping movement of pulley 30 is achieved by molding, bonding, or simply inserting the elastomeric damping member 20 within the spring coil. Elastomeric damping member 20 may comprise any natural or synthetic rubber such as EPDM, VAMAC, NBR, or any combination of two or more of the foregoing. Additional damping can also be added by inserting between the pulley 30 and the torsion spring 20 in the form of a damping member 12. Damping member 12 comprises the same material as member 20.

FIG. 2 is a bottom perspective view of the tensioner. Mounting base 13 is used to mount the tensioner to a mounting surface. Elastomeric member 20 is press fit upon a shaft 14 of base 13. A fastener engages bore 15. Pin 131 on base 13 prevents rotation of the tensioner during operation.

To assemble, torsion spring 10 is press fit or clamped on elastomeric member 20, namely, the inner coil is opened to engage member 20 and then allowed to return to the rest position thereby clamping the spring about member 20. An adhesive known in the art may be used to further fix the torsion spring to member 20 if desired by a user.

FIG. 3 is an exploded view of an alternate embodiment of the tensioner. Member 40 is clamped in the end of arm through damping member 120. Damping member 120 damps vibrations from pulley 30 through member 40. Damping member 120 comprises the same material as damping member 12.

Pulley 30 is journalled to yolk member 40 by a shaft 33. Dust covers 35, 36 prevent debris from entering bearing 31. Hub members 71, 72 locate bearing 31 on shaft 33. Nut 330 engages shaft 33.

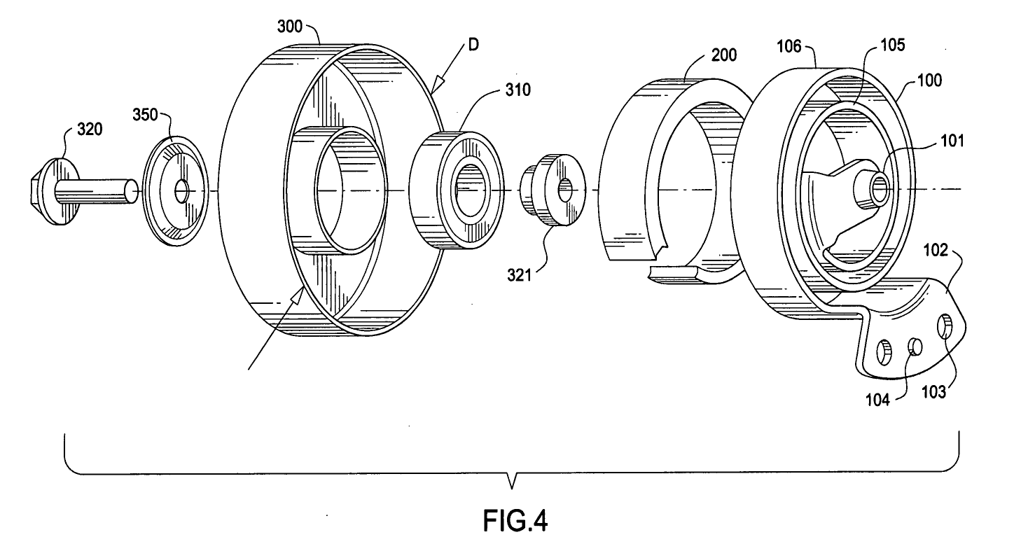

FIG. 4 is an exploded view of an alternate embodiment of the tensioner. The tensioner comprises a torsion spring 100. Elastomeric damping member 200 engages torsion spring 100 between adjacent coils 105, 106 through an arc a of at least 270°, and up to 360°. Elastomeric member 200 may comprise any natural or synthetic rubber such as EPDM, VAMAC, NBR, or any combination of two or more of the foregoing.

Pulley 300 is journalled to torsion spring 100 though a bearing 310. Fastener 320 engages receiving portion 101. Bushing 321 properly locates bearing 320 on portion 101. Dust cover 350 prevents debris from entering the bearing. Pulley 300 has a diameter (D).

A fastener engages hole 103 to fix the tensioner to a mounting surface. Pin 104 prevents the tensioner from rotating during operation.

In this alternate embodiment spring 100 is disposed within a diameter (D) of the pulley 300 and can be attached to bearing 310 in two ways, first, the pulley is bolted on the receiving portion 101 as previously described. In a second method, the spring end is formed into a round loop and the bearing 310 outer race 312 is pressed into the loop. The pulley is then attached to the inner race 311 of the bearing. The inner race rotation of a bearing is advantageous due to less fatigue on the bearing, known in the art. The pulley can either have a hub that is pressed into the bearing ID bore, or, it can be bolted on the bearing inner race top face. In the later case, a very small locating hub of about 2 mm in length would help to locate the bearing in place prior to clamping by a bolt.

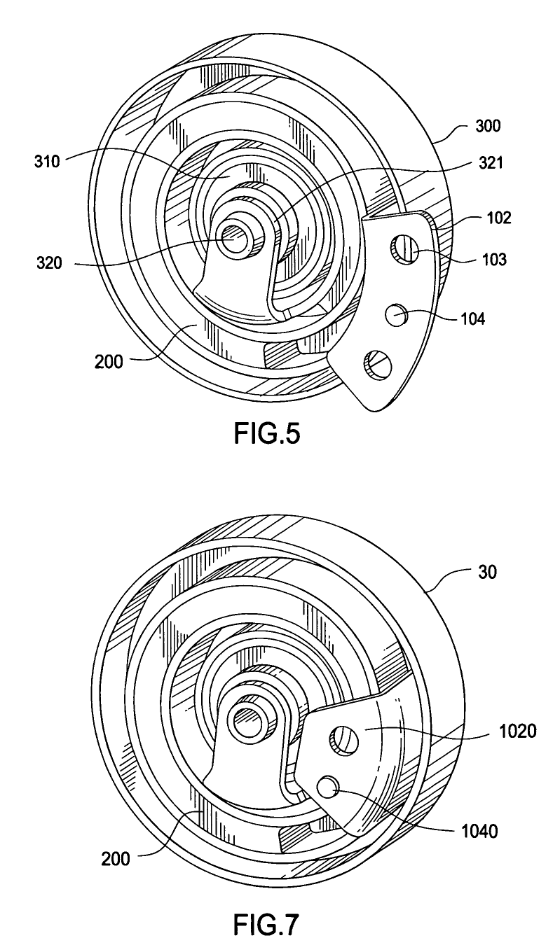

FIG. 5 is a bottom view of the embodiment in FIG. 4. Mounting plate 102 is disposed outside of the pulley diameter (D) for ease of installation.

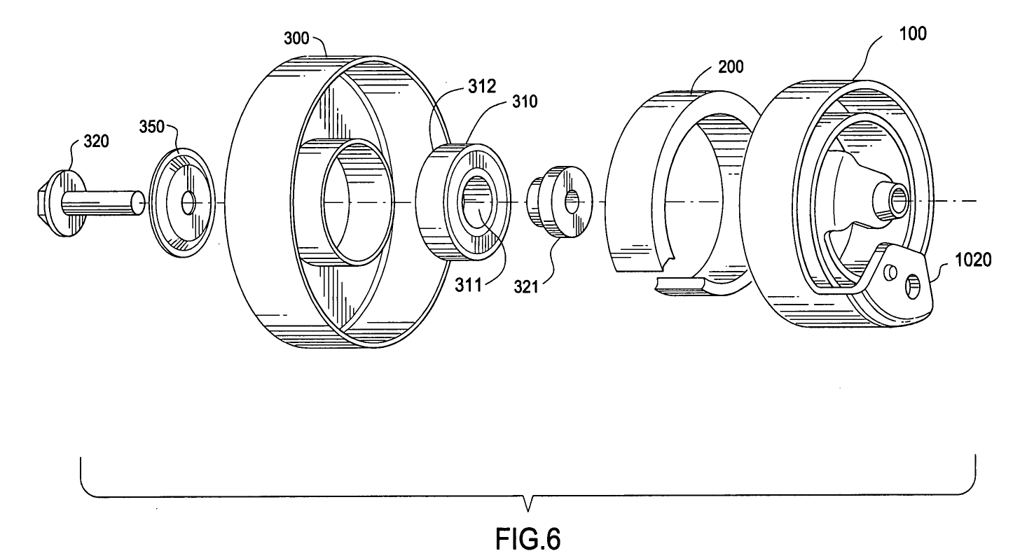

FIG. 6 is an exploded view of an alternate embodiment of the tensioner. The components of this alternate embodiment are the same as those described in FIGS. 4 and 5, with the exception that the mounting plate 1020 is disposed within a diameter (D). In this embodiment the tensioner has to be assembled on the mounting surface without a pulley first, and then the pulley has to be assembled on the tensioner. It is also possible to have access holes on the pulley face to allow the mounting of a fully assembled tensioner to a mounting surface. This allows mounting the tensioner in confined spaces.

FIG. 7 is a bottom view of the embodiment in FIG. 6. Pin 1040 prevents rotation of the tensioner during operation. Pin 1040 engages a receiving hole in a mounting surface (not shown).

Although a form of the invention has been described herein, it will be obvious to those skilled in the art that variations may be made in the construction and relation of parts and method without departing from the spirit and scope of the invention described herein.

I claim:

1. A tensioner comprising:
a torsion spring;
a pulley journalled to an end of the torsion spring;
an elastomeric damping member constrained within a torsion spring coil through an arc of contact of at least 270°; and
the elastomeric damping member in damping contact with the torsion spring coil.

2. The tensioner as in claim 1, wherein the torsion spring is a flat spring.

3. The tensioner as in claim 1, wherein the elastomeric damping member comprises any natural or synthetic rubber such as EPDM, VAMAC, NBR, or any combination of two or more of the foregoing.

4. The tensioner as in claim 1, wherein the torsion spring further comprises a mounting plate disposed within a pulley diameter.

5. The tensioner as in claim 1, wherein the pulley is connected to a yolk member, the yolk member connected to the torsion spring.

6. The tensioner as in claim 1 further comprising a mounting member engaged with the elastomeric damping member for mounting the tensioner to a mounting surface.

7. The tensioner as in claim 1, wherein the pulley is journalled through a damping member which is operationally disposed between the torsion spring and the pulley.

8. A tensioner comprising:
a torsion spring;
a pulley journalled to an end of the torsion spring;
an elastomeric damping member constrained within a torsion spring coil through an arc of contact of less than approximately 270°; and
the elastomeric damping member in damping contact with the torsion spring coil.

9. A tensioner comprising:
a torsion spring;
a pulley journalled to an end of the torsion spring;
an elastomeric damping member constrained within a torsion spring coil through an arc of contact α; and
the elastomeric damping member in damping contact with the torsion spring coil.
